(19) United States
(12) Patent Application Publication
(10) Pub. No.: US 2008/0174076 A1
(43) Pub. Date: Jul. 24, 2008

(54) VACUUM SYSTEM

(75) Inventors: Thomas Eisele, Fluom-Winzeln (DE); Walter Schaaf, Freudenstadt-Gruental (DE)

Correspondence Address: BRINKS HOFER GILSON & LIONE, P.O. BOX 10395, CHICAGO, IL, 60610, US

(73) Assignee: J. Schmalz GmbH, Glatten (DE)

(21) Appl. No.: 12/057,063

(22) Filed: Mar. 27, 2008

Related U.S. Application Data
(63) Continuation of application No. PCT/EP2006/007818, filed on Aug. 8, 2006.

(30) Foreign Application Priority Data
Sep. 28, 2005 (DE) 10 2005 047 385.7
Mar. 24, 2006 (EP) PCT/EP2006/004968
Mar. 31, 2006 (DE) 10 2006 016 235.8
Mar. 31, 2006 (DE) 10 2006 016 236.6

(51) Int. Cl. B23B 31/30

(52) U.S. Cl. 279/3

(57) ABSTRACT

The invention relates to a vacuum system, in particular a vacuum gripping system having at least one vacuum gripping apparatus for gripping workpieces and/or a vacuum component, in particular having a sensor for sensing states in the vacuum gripping system and/or one of the components and for generating state data, wherein the vacuum gripping apparatus and/or at least one of the components is equipped with an energy generation device for generating new electrical energy, which is not stored in the vacuum system, for operating a module consuming electrical energy.

### CROSS-REFERENCE TO RELATED APPLICATIONS

This application is a continuation of International Application No. PCT/EP2006/007818 filed on Aug. 8, 2006, which claims the benefit of DE 10 2005 047 385.7-22, filed Sep. 28, 2005, DE 10 2006 016 235.8, filed Mar. 31, 2006 DE 10 2006 016 236.6, filed Mar. 31, 2006, and PCT/EP2006/004968, filed Mar. 24, 2006. The disclosures of the above applications are incorporated herein by reference.

### FIELD

The invention relates to a vacuum system, in particular a vacuum gripping system having at least one vacuum gripping device for gripping workpieces and/or a vacuum component.

### BACKGROUND

The statements in this section merely provide background information related to the present disclosure and may not constitute prior art.

Vacuum systems are used for the production of low pressure and the handling of objects. An example of a device for the production of low pressure is an ejector, which is operated with compressed air and to which vacuum consumers are connected. An example of a vacuum consumer of this type is a suction gripper, by means of which an object is sucked in so that it can be picked up and transported to another place. There are, however, also known gripping systems which are used for gripping workpieces, so that the workpieces can be processed. The individual vacuum gripping devices and the components which work with them are subject to wear and must accordingly be monitored in order to ascertain whether they show leaks and/or still work properly. It may also be necessary to ascertain particular data on the status of these components—for example, the level of the partial vacuum which prevails within them—in order to enable them to continue to operate. Thus, for example, a workpiece which has been sucked in can only be picked up when the partial vacuum in the suction gripper has reached a predetermined value.

To this end, sensors are provided, which record the statuses and convert them into status data, whereby the status data can then be transmitted by cable to a receiver. In addition, cables are required in order to provide the sensors with electrical energy; however, effort and expense are required for cabling. For example, providing cabling for status requires that not only that the compressed air and partial vacuum devices be installed, but also the energy supply cables and the data transmission cables.

### SUMMARY

The invention is accordingly based on the task of producing a vacuum system of simpler construction.

The vacuum gripping device of the present disclosure and/or at least one of the components exhibits an energy generation device for the production of new electrical energy, which is not stored in the vacuum system, for the operation of an electrical energy-consuming component.

The device according to the invention does not require electrical supply lines for energy supply, because the energy is generated on site by means of the energy generation device. This electrical energy is preferably not taken from an original energy storage unit included in the vacuum system; rather, it is converted from a form of energy existing in the environment or derived from another form of energy which exerts an effect on the vacuum system, such as, for example, motion energy or light.

The vacuum system of the present invention may have an element for the recording of statuses in the vacuum system, which may be located within the vacuum gripping system and/or in one of the components, for the generation of status data.

According to the invention, the electrical energy required for recording of the statuses and the generation of the status data is no longer required to be supplied to the vacuum system by means of cables, because the vacuum gripping device and/or at least one of the components used by it is provided with an energy generation device, so that the required electrical energy is generated on site. This electrical energy is not taken from an original energy storage unit; rather, it is converted from another form of energy and may be taken from the environment.

Preferably, the electrical energy-consuming component is a sensor, a transmitter, an optical and/or acoustic display, a valve, an actuator, or a data storage unit. Should the status data be transmitted in a wireless manner by means of a transmitter, the transmitter in question will also be provided with energy by the energy generation device. In other words, it will require no cabling for transmission of the status data to a receiver located outside the vacuum system, because these status data are transmitted to it in a wireless manner by means of a transmitter. Accordingly, the entire cabling of the system becomes unnecessary, so that only the air supply lines must be installed. In this way, the effort and expense required for construction are significantly reduced, and repairs and maintenance operations can be performed more quickly and simply. In addition, the weight and size of the system are reduced.

The vacuum gripping device may consist of a suction gripper, a vacuum clamping system, or another device capable of directly or indirectly holding a workpiece by means of partial vacuum. Suction grippers are used to suck in objects, so that they can be picked up and moved to another place. Vacuum clamping systems allow components to be held fast, so that they can subsequently be processed. These components can be equipped with the energy generation device, so that their status data—for example, switching cycles, partial vacuum applied, amounts of air supplied and so forth—can be recorded and either stored in the component and/or transmitted to an external receiver. Storage of the data can be implemented, for example, by an RFID (Radio Frequency Identification Device), which is fastened to a suitable place on the suction gripper or the vacuum clamping system. In this way, the usage history of the component is not lost and can be called up at any time.

The component may consist of an ejector, a vacuum pump, a vacuum bellows, a valve, a data storage unit, a suction gripper, a spring-loaded plunger, a vacuum switch, or a display, by way of example. The valve may be an electromagnetic valve, a pneumatic valve, or a touch valve, by way of example. In these components as well—whereby the abovementioned list is intended by way of example only—an energy generation device may be provided, which supplies the energy for the sensors for recording the individual status data, and the data may be directly transmitted to and stored in a data storage unit on site and/or transmitted to an external receiver. The energy used in storage and transmission is similarly provided by the energy generation device. In addition, it should be noted a rechargeable energy storage unit, for example, a battery, an accumulator, a condenser, or a fuel cell, may also be provided, so that small quantities of energy generated by the energy generation device can be accumulated.

In one preferred form, the energy generation device may be a piezoelectric element. It is also, however, contemplated that thermocouples, oscillation converters, induction generators, or turbines with generator or photovoltaic cells, may be used, by way of example. The individual components may subjected to mechanical stress, for example, when handling objects, whereby these mechanical movements can be converted by the piezoelectric elements or induction generators into electrical energy, so that the electrical energy for sensors, transmitters and storage units can be provided. In this context, the piezoelectric element and/or the induction generator is preferably located in or on a section which is moved mechanically—for example, on a piston, a cylinder wall, or a touch valve—which, when attached to a workpiece, is inserted into the suction device. The section, for example, can also be transformed in shape when the workpiece is gripped. This transformation energy accomplishes the transformation of the piezoelectric element and/or the induction generator, which converts the mechanical energy into electrical energy. In another variation, a turbine may be used, which may be located in the suction or air blast stream, and which may drive a generator.

The sensor is preferably a vacuum sensor, a flow sensor, an air quantity sensor, a counter, a movement sensor, a temperature sensor, a distance sensor, a presence sensor, or a force sensor. In this way, an extremely wide variety of statuses can be determined and corresponding data can be generated. Thus, for example, the wear limit of a suction gripper can be recognized before the suction gripper stops working. In addition, it is also possible to recognize when an object is not correctly sucked in or gripped, and thereby to prevent accidents.

The transmitter can be a radio transmitter, an infrared transmitter, an ultrasound transmitter, or a wired signal generator, by way of example. The data may be encrypted or unencrypted and may be combined with component-dependent original features. In this way, it is possible to determine, at any time, where and when the data were generated.

The vacuum gripping device and/or the vacuum component may exhibit a data storage unit for the storage of status data and/or data relevant to the vacuum gripping device and/or the vacuum component. This data storage unit can be read out during operation and/or in cases requiring service or repair. This may enable the more rapid tracing of any causes of error.

The vacuum gripping device and/or the vacuum component may be driven by means of the data stored in the component. These data can be predetermined; they can also, however, be generated in the course of the current operation and can thereby have an affect on the following operation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 a schematic diagram of a vacuum gripping system, according to the principles of the present invention;

FIG. 2 is a schematic diagram of a suction device having a battery-free radio module and an external storage unit, in accordance with the principles of the present invention;

FIG. 3 is a schematic diagram of suction grippers having an external storage unit, according to the principles of the present invention;

FIG. 4 is a schematic diagram of a process showing the suction and lifting of an object, in accordance with the principles of the present invention;

FIG. 5 is a schematic diagram of a suction gripper having an integrated storage unit, according to the principles of the present invention;

FIG. 6 is a schematic diagram of a suction device having a battery-free radio module and an internal storage unit, in accordance with the principles of the present invention;

FIG. 7 is another schematic diagram of the suction device of FIG. 6;

FIG. 8 is a schematic diagram of a suction device 42 having a radio module and an energy buffer, in accordance with the principles of the present invention;

FIG. 9 is a schematic diagram of a mechanical vacuum switch having a radio module, according to the principles of the present invention;

FIG. 10 is a schematic diagram of a mechanical vacuum switch having a radio module with a buffer, in accordance with the principles of the present invention;

FIG. 11 is a schematic diagram of an electrical vacuum switch having a radio module, according to the principles of the present invention;

FIG. 12 is a schematic diagram of an ejector having a turbine located in its air stream, in accordance with the principles of the present invention;

FIG. 13 is another schematic diagram of the ejector of FIG. 12;

FIG. 14 is a schematic diagram of a touch valve having an induction generator and a radio transmitter, in accordance with the principles of the present invention;

FIG. 15 is a schematic diagram of a valve cluster, according to the principles of the present invention;

FIG. 16 is a schematic diagram of spring-loaded plunger having immersion depth monitoring, in accordance with the principles of the present invention; and

FIG. 17 is another schematic diagram of the spring-loaded plunger of FIG. 16.

### DETAILED DESCRIPTION

The following description is merely exemplary in nature and is not intended to limit the present disclosure, application, or uses.

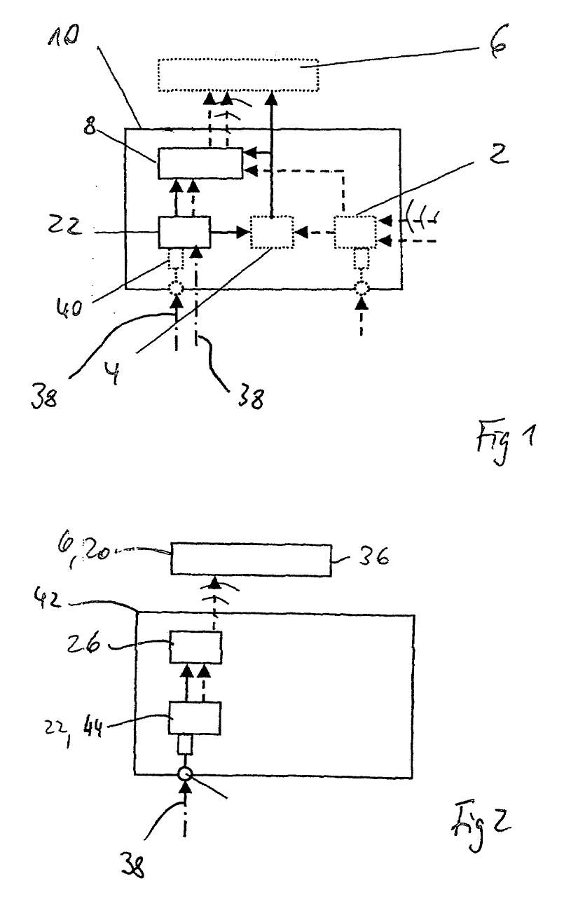

FIG. 1 is a schematic diagram of a vacuum gripping system generally designated at 10, in which is located an energy generation device 22, which is connected to an electrical energy-consuming component 8, for example, a display, a sensor, a valve, a wired signal generator, a transmitter, or a data storage unit, by way of example. This component 8 communicates with an external unit 6, for example, in order to read, write, evaluate or display. In addition, the vacuum gripping system 10 is provided with an additional energy buffer 4, for example, a battery, an accumulator, or a condenser, for example, to which may be connected an additional optional signal generator 2, for example, a switch, a cable, a (radio) receiver, a sensor, or a timer, by way of example.

In FIG. 1, the solid arrows represent a flow of electrical energy, the dot-and-dashed arrows represents a flow of non-electrical energy, the dashed arrows symbolize a flow of information over a physical connection, and the dashed arrow with concentric arcs symbolize a flow of information with no cable, line or hose. Arrow 38 symbolizes energy which has an effect on the vacuum gripping system 10. For activation of the consumer 8, either a signal from the signal generator 2 or an electrical pulse from the energy generation device 22 may be used. Finally, the element 40 represents another mechanical actuation.

FIG. 2 shows a schematic diagram of a suction device 42 with a battery-free radio module and an external storage unit. Element 44 is an induction generator or a piezoelectric element which operates a radio transmitter 26. The energy generator 22, in the form of an induction generator or piezoelectric element 44, emits an electrical pulse which represents a signal. The unit 6 is an external data storage unit 20.

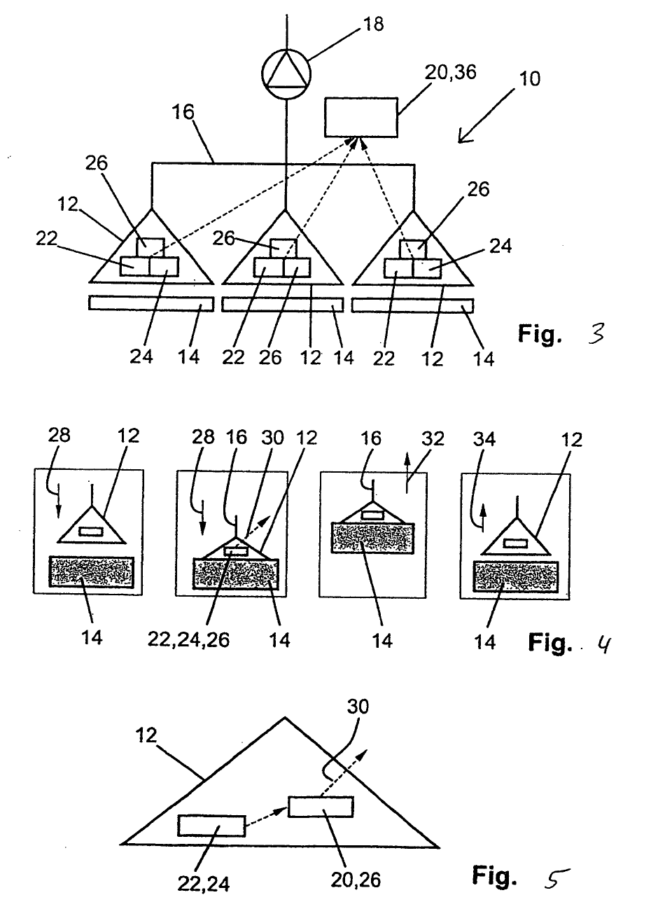

FIG. 3 shows the vacuum gripping system 10 with three suction grippers 12, by means of which workpieces 14 can be sucked in. The suction grippers 12 are connected, by means of a partial vacuum line 16, to a partial vacuum supply device 18, for example, a partial vacuum pump or an ejector. In addition, it may be seen that an external data storage unit 20 is provided. Accordingly, the ejector itself represents a vacuum component.

Integrated into each individual suction gripper 12 is an energy generation device 22, a so-called energy converter, and a sensor 24. This sensor 24 records statuses of the suction gripper 12, for example, the partial vacuum prevailing in the suction gripper 12 or the number of load cycles; it then generates status data and transmits them, by way of a transmitter 26, to the data storage unit 20. The electrical energy required to operate the sensor 24 and to operate the transmitter 26 is generated by the energy generation device 22, which, for example, maybe a piezoelectric element or an induction generator, a photovoltaic cell, a turbine, an oscillation converter, or a thermocouple, by way of example.

FIG. 4 shows one variation of a process for the handling of a workpiece 14, in which the suction gripper 12 is first lowered in the direction of the arrow 28 onto the workpiece 14, until the suction gripper 12 is attached to the workpiece 14. In the process, the suction gripper 12 is transformed in shape, whereby the mechanical transformation energy is converted into electrical energy by the energy generation device 22. This activates the transmitter 26, which sends an activation signal to the receiver located in the data storage unit 20, as indicated by means of the arrow 30.

This has the effect of setting the partial vacuum supply device 18 in operation and thereby providing the partial vacuum line 16 with a partial vacuum. The workpiece 14 is sucked in. Once the required suction pressure has been obtained, as determined by the sensor 24, an additional signal is issued, indicating that the object 14 can now be picked up (arrow 32), because the partial vacuum prevailing in the suction gripper 12 is strong enough. Should the partial vacuum in the suction gripper 12 become weaker, this will also be recognized by the sensor 24, so that an additional signal can be transmitted. When the partial vacuum reaches its required value, the partial vacuum supply device 18 can be switched off or the partial vacuum line 16 can be blocked.

After the workpiece 14 has been gripped, which is again registered by the sensor 24, the partial vacuum line 16 is supplied with air, so that the suction gripper 12 can be removed from the object 14 in the direction of the arrow 34.

The vacuum system according to the invention requires no electrical lines for provision of energy to the sensor 24 and the transmitter 26; instead, the vacuum system may be provided merely with the supply of a partial vacuum to the suction gripper 12.

FIG. 5 shows an example of a suction gripper 12, in which the data storage unit 20 is integrated into the suction gripper 12, for example, in the form of an RFID tag. This suction gripper 12 likewise transmits data (arrow 30) to an external receiver 36; however, the usage history is stored in the internal storage unit 20 and can also be read out later. In addition to the usage history, identification numbers, the manufacturing date, the manufacturer, material designations, and the like may also be stored. In this way, it is possible to draw conclusions with regard to incorrect operation, faulty manufacture, and the like.

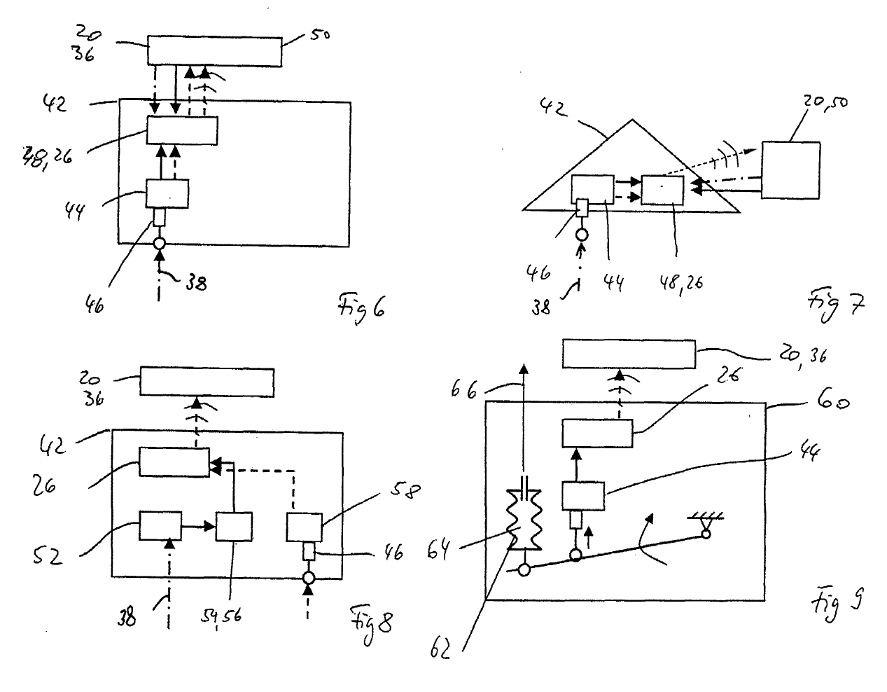

FIGS. 6 and 7 illustrate a suction device 42 having a battery-free radio module and an internal storage unit. Located in the suction device is an induction generator or piezoelectric element 44, which, for example, is actuated by means of a plunger 46 or by means of an elastic section of the suction device 42, and which supplies a data storage unit 48 and a radio transmitter 26 with electrical energy. Instead of the external data storage unit 20, it is also possible to provide an external display 50 or a signal converter, for example, for a programmable controller, a robot controller or another superordinate controller, by way of example.

FIG. 8 illustrates of a suction device 42 having a radio module and an energy buffer. The suction device 42 contains a photovoltaic cell 52, by means of which electrical energy is generated. This energy is stored in an energy buffer 56 in the form of a condenser 54. The plunger 46 activates an electromechanical switch 58.

FIG. 9 is a schematic diagram of a mechanical vacuum switch 60 with a radio module. Located in the vacuum switch 60 is an induction generator or piezoelectric element 44; the actuation element consists of a bellows 62 or a piston, to which a partial vacuum 64 can be supplied by sucking out the air in the direction of the arrow 66. This embodiment is used in process control and automation.

FIG. 10 shows a sketch in principle of a mechanical vacuum switch 60 with a radio module and a buffer 56, which is formed by a condenser 54. Located in the vacuum switch 60 is a photovoltaic cell 52, by means of which electrical energy is produced from light 68. This energy is stored in an energy buffer 56 in the form of a condenser 54.

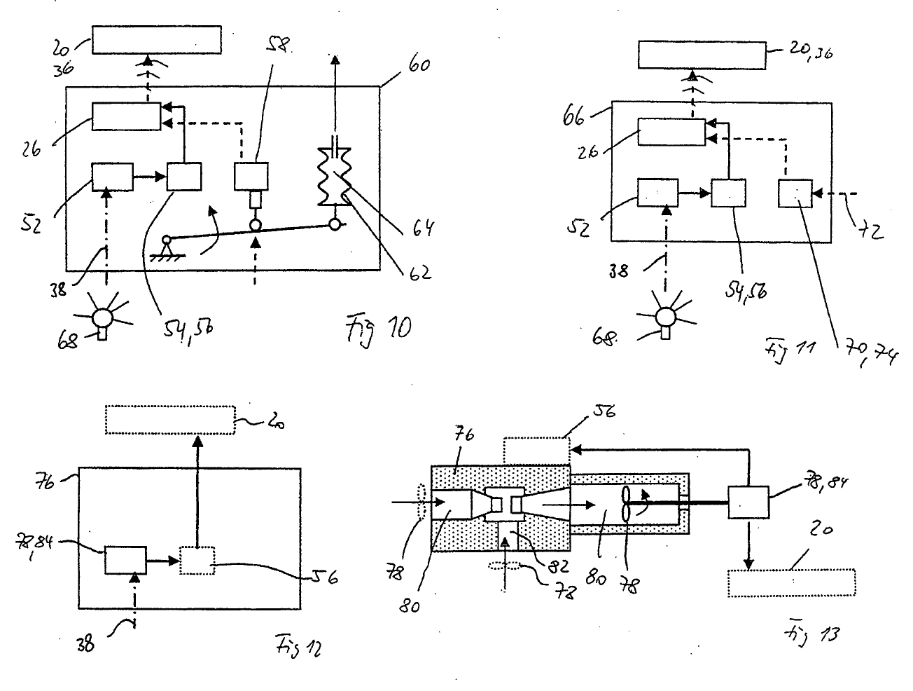

FIG. 11 is a schematic diagram of an electrical vacuum switch 66 with a radio module 26 and a buffer 56. Transmission pulses are generated by the vacuum switch 66 upon the obtaining of a switching threshold 70 determined by either an excess or a shortfall, whereby the vacuum switch 66 is connected by means of a hose 72 to the partial vacuum to be monitored. In one variant, the transmission pulses are controlled by means of a timer 74. The sensor measures the vacuum value, for example, every two seconds, and sends an analog signal to a superordinate controller.

FIGS. 12 and 13 illustrate an ejector 76, in whose air stream a turbine 78 is located. The air stream is either an air blast stream 80 or a suction stream 82. The turbine 78 drives a generator 84 for production of electrical energy. The turbine 78 located at the outlet of the air blast stream 80 thereby works as a muffler, because it slows the air stream.

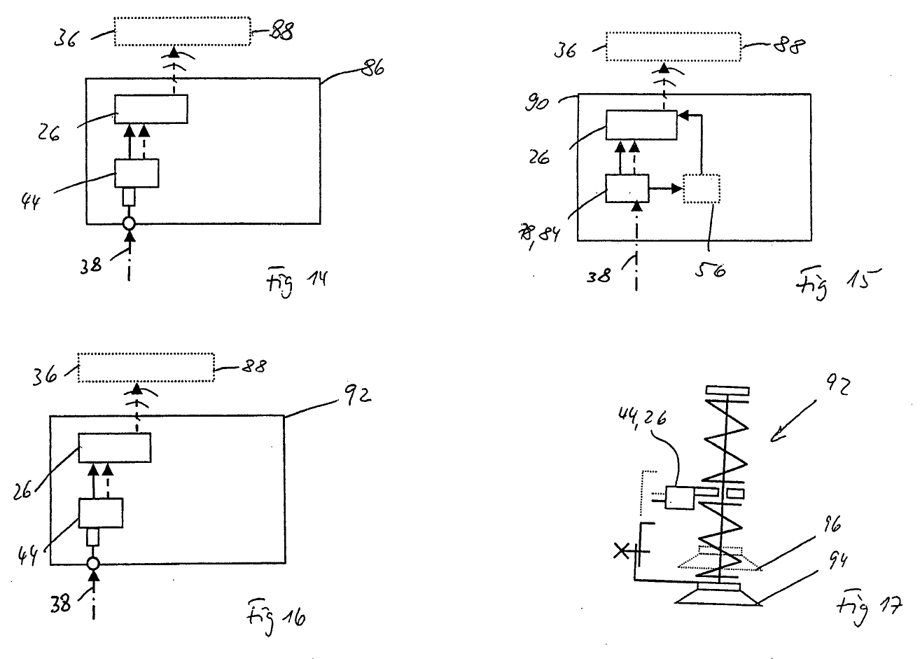

FIG. 14 illustrates a touch valve 86 having an induction generator 44 and a radio transmitter 26. The sent and received data are processed in the signal converter 88 for a robot controller. When the touch valve 86 touches the object, a plunger is immersed and the induction generator 44 is actuated, so that the radio transmitter 26 is supplied with electrical energy for transmission.

FIG. 15 is a schematic diagram of a valve cluster 90, in which a suction or air blast stream is used to drive the turbine 78.

FIGS. 16 and 17 show a sketch in principle of a spring-loaded plunger with adjustable immersion depth monitoring. In FIG. 17, the solid line represents the extended position 94, and the dotted line represents the immersed position 96, of the spring-loaded plunger 92.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A vacuum gripping system comprising at least one of a vacuum component and a vacuum gripping device for gripping an object, the at least one of a vacuum component and a vacuum gripping device having an energy generation device configured to produce electrical energy that is not originally stored in the vacuum gripping system, the energy generation device being configured to operate an electrical energy-consuming component.

2. The vacuum gripping system according to claim 1, wherein the electrical energy-consuming component is at least one of a vacuum generator, a sensor, a transmitter, a display, an actuator, and a data storage unit.

3. The vacuum gripping system according to claim 2, wherein the electrical energy-consuming component is a sensor, the sensor being at least one of a vacuum sensor, a flow sensor, an air quantity sensor, a counter, a movement sensor, a temperature sensor, a distance sensor, a presence sensor, and a force sensor.

4. The vacuum gripping system according to claim 2, wherein the electrical energy-consuming component is a transmitter, the transmitter being at least one of a radio transmitter, an infrared transmitter, an ultrasound transmitter, and a wired signal generator.

5. The vacuum gripping system according to claim 1, wherein the at least one of a vacuum component and a vacuum gripping device is a vacuum gripping device, the vacuum gripping device being at least one of a suction gripper, a vacuum clamping system, and a holding device capable of directly or indirectly holding a workpiece while employing a partial vacuum.

6. The vacuum gripping system according to claim 1, wherein the at least one of a vacuum component and a vacuum gripping device is a vacuum component, the vacuum component being at least one of an ejector, a valve, a data storage unit, a suction gripper, a spring-loaded plunger, a vacuum switch, a vacuum pump, a vacuum bellows, and a display.

7. The vacuum gripping system according to claim 6, wherein the vacuum component is a valve, the valve being at least one of an electromagnetic valve, a pneumatic valve, and a touch valve.

8. The vacuum gripping system according to claim 1, wherein the energy generation device is at least one of a piezoelectric element, a thermocouple, an oscillation converter, an induction generator, a turbine having a generator, and a photovoltaic cell.

9. The vacuum gripping system according to claim 8, wherein the energy generation device is a turbine having a generator, the turbine being located in an air stream.

10. The vacuum gripping system according to claim 9, wherein the air stream is one of an air blast stream and a suction stream.

11. The vacuum gripping system according to claim 1, wherein the energy generation device is located in or on a section, wherein the section is configured to be mechanically moved.

12. The vacuum gripping system according to claim 11, wherein the section is configured to be transformed in shape or moved when attached to a workpiece or when gripping a workpiece.

13. The vacuum gripping system according to claim 11, wherein the section is an elastic portion that is configured to be displaced when attached to a workpiece.

14. The vacuum gripping system according to claim 1, further comprising a transmission device configured to transmit status data to a receiver.

15. The vacuum gripping system according claim 1, wherein the energy generation device is connected to an energy storage unit.

16. The vacuum gripping system according to claim 15, wherein the energy storage unit is at least one of a battery, an accumulator, a condenser, and a fuel cell.

17. The vacuum gripping system according to claim 1, further comprising a recording element configured to record statuses in the vacuum gripping system and to generate status data.

18. The vacuum gripping system according to claim 13, wherein the elastic portion is one of a suction partition and a touch valve.
